(19) United States
(12) Patent Application Publication
(10) Pub. No.: US 2011/0231637 A1
(43) Pub. Date: Sep. 22, 2011

(54) CENTRAL PROCESSING UNIT AND METHOD FOR WORKLOAD DEPENDENT OPTIMIZATION THEREOF

(75) Inventor: Franz Michael Schuette, Colorado Springs, CO (US)

(73) Assignee: OCZ TECHNOLOGY GROUP, INC., San Jose, CA (US)

(21) Appl. No.: 12/886,796

(22) Filed: Sep. 21, 2010

Related U.S. Application Data
(60) Provisional application No. 61/244,274, filed on Sep. 21, 2009.

(51) Int. Cl. G06F 9/30

(52) U.S. Cl. 712/229; 712/E09.016

(57) ABSTRACT

A central processing unit (CPU) adapted for use in a computing system, such as a personal computer or other processing apparatus. The CPU is implemented to perform hyper-threading (HT), and further enables switching between HT-enabled and HT-disabled modes on the fly (without rebooting the apparatus) based on, for example, performance measurements or entries into a local library.

### CROSS REFERENCE TO RELATED APPLICATIONS

This application claims the benefit of U.S. Provisional Application No. 61/244,274, filed Sep. 21, 2009, the contents of which are incorporated herein by reference.

### BACKGROUND OF THE INVENTION

The present invention generally relates to central processors for use with computing systems and other processing apparatuses. More particularly, this invention relates to a central processing unit (CPU) that is enabled for hyper-threading (HT), and is further capable of switching between HT-enabled and HT-disabled operation without rebooting the computing system in which it is installed.

The core of a central processing unit (CPU) is that part of the CPU that performs the operation of reading and executing instructions. CPUs, particularly those based on x86 architecture, have evolved from relatively simple designs that had a single core capable of processing a single instruction at a time, to extremely complex devices comprising multiple cores that are each independently capable of processing an instruction. Of particular interest in this case is the adaptation to symmetric multiprocessing (SMP), which has been a push-pull between hardware and operating system-based support. In addition to the operating system (OS), applications must also be aware of SMP, that is, they must support multiple threads in order to take advantage of the extra processor cores.

In the situation where multiple applications may simultaneously run on the same computer, multiple threads may be funneled through the same front end of a CPU to its execution units (functional units), which constitute that part of a CPU that performs the operations and calculations called for by a computer program. In any multitasking environment, this can lead to a situation where the number of threads exceeds the number of processor cores. Likewise, most modern software applications are multithreaded, meaning that they can split the workload over several threads for parallel processing of the workload. One of the issues encountered is that there are lags when switching between threads, that is, one thread has been processed but there are valuable CPU cycles wasted before processing of the next thread can begin by the execution units in the CPU core. The result is very often that only as little as about one third of the maximum possible instructions per clock cycle are executed because of lack of data to be processed.

A proposed solution to this problem has been commercialized by Intel Corporation under the name Intel® Hyper-Threading Technology (Intel® HT Technology), sometimes referred to as hyper-threading technology (HTT) or more simply hyper-threading (HT). Hyper-threading is a simultaneous multithreading implementation, by which a small portion of a CPU, specifically the architectural state, is duplicated. The architectural state is the part of the CPU that holds the state of a process and comprises control registers such as instruction flag registers, interrupt mask registers, memory management unit registers and status registers, as well as general purpose registers including adder, address, counter, index, stack and string registers. In other words, the architectural state serves as an interface between the system memory and the execution units, and schedules the workload in the most efficient way.

From a functional standpoint, the architectural state is the part of the processor that is visible to the operating system, in that the state of processes is what determines the call for the next workload. Consequently, duplicating the architectural state allows a single processor to appear as two CPUs, as long as the operating system supports symmetric multiprocessing and uses the additional registers for streamlining multiple threads for execution.

Hyper-threading, however, is not without drawbacks. Among the problems encountered are cache contention, that is, because of the relatively small size of the Level 1 cache, it may not be able to hold data pertaining to two threads, and consequently the cache must be evicted to make room for data relating to the new thread. This scenario is particularly problematic if two unrelated applications are competing for the same execution units and processed in alternating small chunks. In this case, hyper-threading can cause a substantial performance hit because of cache contention or cache pollution. So far, Hyper-threading can be enabled or disabled on boot-up of a computer system through the Basic Input-Output System (BIOS), more specifically through changes in the CMOS setup only, which does not allow changing from HT-enabled to HT-disabled operation on the fly while the system is up and running. Since the workload of any computer system goes through multiple scenarios between shut-downs and re-boots, the ability to perform an on-the fly reconfiguration would be highly advantageous.

### BRIEF DESCRIPTION OF THE INVENTION

The present invention provides a CPU and method suitable for use with computing systems, such as personal computers and other processing apparatuses.

According to a first aspect of the invention, the CPU is implemented for hyper-threading (HT), and is further capable of switching between HT-enabled and HT-disabled operation without rebooting the computer. According to a particular embodiment of the invention, the CPU is operable to switch between HT-enabled and HT-disabled operation in response to a software application running on the computing system. For example, the CPU may switch between HT-enabled and HT-disabled operation based on comparative execution times of application workload while the HT operation of the CPU is enabled and disabled, or a signal generated by code in a software application running on the computing system. In preferred embodiments, the CPU has a plurality of physical cores and a plurality of virtual cores, and the latter of which are enabled and disabled for, respectively, HT-enabled and HT-disabled operation of the CPU.

According to a second aspect of the invention, the method involves using the CPU described above to switch a computing system between HT-enabled and HT-disabled operation without rebooting the computing system.

According to preferred aspects of the invention, an HT-implemented CPU capable of switching between HT-enabled and HT-disabled operation on the fly during continuous operation of a computing system, and therefore without requiring rebooting of the system, can achieve improved processing efficiency. In particular, by enabling HT, outstanding workloads consisting of different threads can be scheduled in an interleaved fashion to minimize waiting periods and ensure maximum efficiency of data delivery to the execution units of the CPU. On any given workload associated with one or more software applications running on a computing system, the system can perform a spot-check on performance using only physical cores, corresponding to an HT-disabled mode of the CPU, as well as using both physical and virtual cores, corresponding to an HT-enabled mode of the CPU, to determine whether HT-enabled or HT-disabled is more efficient and accordingly select the operation mode of the CPU.

Other aspects and advantages of this invention will be better appreciated from the following detailed description.

### BRIEF DESCRIPTION OF THE DRAWINGS

FIG. 1 is a flow diagram of a software application that has been launched in a computing system that contains an HT-implemented CPU, and the use of performance checks to enable the selection of either HT-enabled or HT-disabled operation of the system, whichever appears to be the optimal configuration for the system while running the application.

FIG. 2 shows a flow diagram of a software application that has been launched in a computing system that contains an HT-implemented CPU, and a library for reference when attempting to determine the best performance mode (HT-enabled or HT-disabled) for the system.

FIG. 3 shows a multitasking scenario in which several software applications are simultaneously running on a computing system, and the applications interact with each other to optimize the processing state of the system and store optimization parameters in a library.

### DETAILED DESCRIPTION OF THE INVENTION

The present invention is generally applicable to computing systems, and particularly to personal computers and other processing apparatuses that utilize CPUs. The invention involves optimizing a CPU for dynamically changing software landscapes.

According to preferred embodiments of the invention, the CPU has duplicate architectural states, which are visible to a computer operating system as a duplication of the CPU's cores, even if only a single physical core is present in the CPU. In other words, a relatively small amount of silicon real estate can provide a physical core of the CPU as well as generate a virtual core of the CPU. In the present invention, duplication occurs and a virtual core can be used if an HT-enabled mode of operation is selected for the CPU. For workloads capable of taking advantage of HT operating modes, the execution efficiency of a physical core can be maximized by seamlessly scheduling independent threads to the core, meaning that one architectural state feeds data to the core during periods where the other architectural state has wait states between threads. Accordingly, the execution efficiency of the CPU can be optimized by alternatingly scheduling threads to execution units of the CPU. The duplicate architectural states can be disabled after flushing all data, and can be enabled on the fly without rebooting the computing system (for example, a personal computer) in which the CPU is installed. Consequently, the operating system will either see only a single instance of the physical cores or a virtual duplication of the execution units based on whether the second instance of the duplicate architectural states is activated or inactivated.

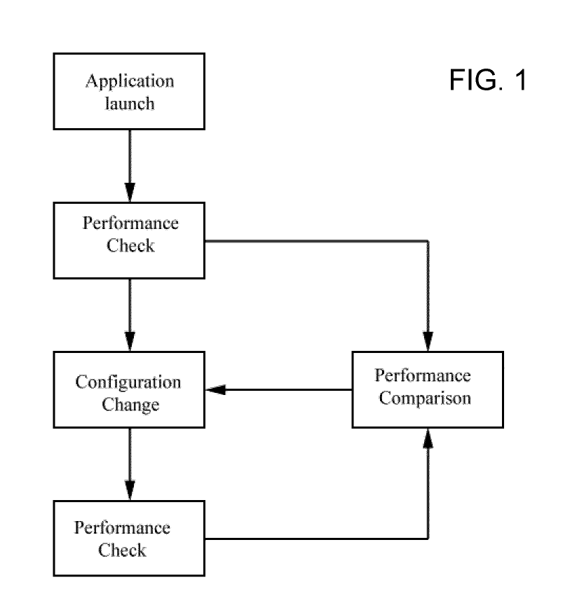

FIG. 1 represents steps that may be performed during the operation of a computing system according to a first embodiment of the invention. In particular, FIG. 1 represents a process in which a software application is launched in a computing system containing a CPU that is implemented for hyper-threading (HT). At some point in time after launching the application, the system initiates a brief performance spot-check. For example, a representative part of the workload of the application is executed and a first execution time is logged. Subsequently, the CPU is caused to change its configuration from either HT-enabled to HT-disabled, or HT-disabled to HT-enabled, depending on the original operating state of the CPU. The CPU then executes the same or equivalent workload to arrive at a second execution time, after which the first and second execution times are compared. On the basis of this comparison, a more efficient (faster execution) configuration for the CPU (either HT-enabled to HT-disabled) can be chosen for the system.

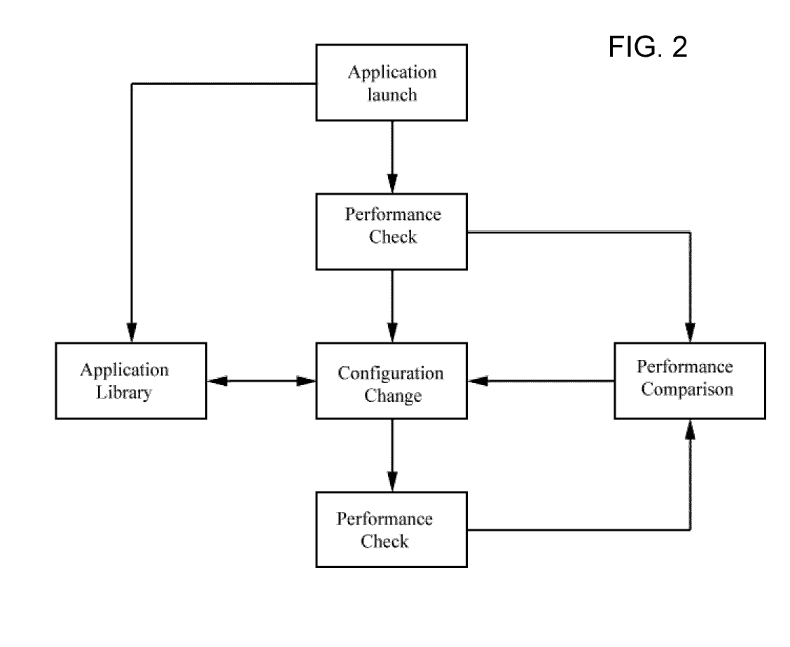

In order to quicken or facilitate the selection process, the result of the comparative performance analysis can be stored in an application library for future reference when attempting to determine the best performance mode when running a software application, as represented in FIG. 2. In particular, a configuration change operation can store and access performance data in the library, such that the decision to change the configuration of the CPU between HT-enabled and HT-disabled state change takes into consideration past performances of the computing system when running the application in HT-enabled and HT-disabled operating modes. As another option, a software manufacturer may add code to their software application that signals the CPU to enable or disable its HT operation upon launching of the application. Moreover, if so desired, the computing system can periodically recalibrate itself to take into account changes in the workload. For example, additional applications and services running on the same system may change the performance parameters and require a reconfiguration between HT-enabled and HT-disabled operation of the CPU.

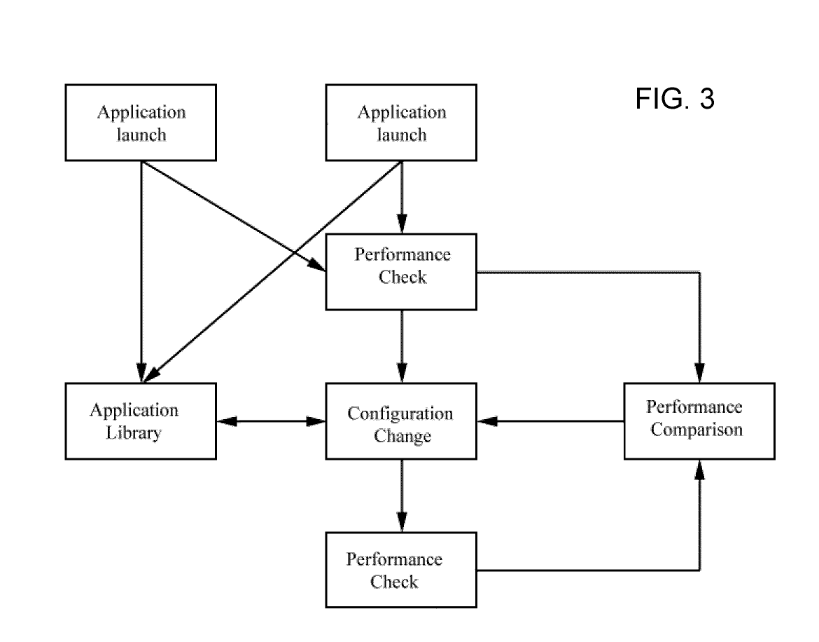

In a multitasking situation where several applications are running simultaneously and competing for CPU resources, the particular scenario can be evaluated by testing a combination of the different applications in the specific workloads they are running, as represented in FIG. 3. It is understood that also in this case, the application-specific configuration data, as well as data pertaining to any combination of different applications, can be stored in a library.

Reconfiguration of the architectural state based on performance checking will cause some performance hit, particularly in small workloads. However, particularly in this type of workload, CPU performance is not necessarily the limiting factor for overall productivity. Rather it is the massive recalculation of large workloads that system performance hinges on the CPU's efficiency and optimizations make a difference in the overall productivity. Moreover in most environments, the enabling of HT will constitute the more efficient (faster execution) solution, and therefore it may be advantageous to use this setting as default but allow the user to enter a toggle mode in which the system performs the performance checks outlined above. Likewise, applications can be flagged by the application publisher to specifically disable HT in order to streamline the configuration optimization. Finally, it may be desirable to enable the user to manually disable the performance checks or either of the HT-enabled and HT-disabled modes of the CPU.

While the invention has been described in terms of specific embodiments, it is apparent that other forms could be adopted by one skilled in the art. For example, the physical configuration of a computing system and CPU implementing the present invention can considerably vary, and functionally-equivalent components could be used or subsequently developed to perform the intended functions of the disclosed components. Therefore, the scope of the invention is to be limited only by the following claims.

1. A central processing unit adapted for use with a computing system, the central processing unit being implemented for hyper-threading (HT) and capable of switching between HT-enabled and HT-disabled modes without rebooting the computer.

2. The central processing unit of claim 1, wherein the central processing unit has a plurality of physical cores and duplicate architectural states through activation of which virtual cores can be added to the physical cores of the central processing unit, and wherein the virtual cores enable and disable, respectively, the HT-enabled and HT-disabled modes of the central processing unit.

3. The central processing unit of claim 2, wherein the central processing unit is operable to improve processing efficiency of the computing system by speeding up data delivery to execution units of the central processing unit through scheduling workload in an overlapping fashion to the virtual cores.

4. The method of claim 1, wherein the central processing unit is operable to perform a performance check by selectively operating in the HT-enabled and HT-disabled modes while a software application is running on the computing system, and then selecting the HT-enabled mode or the HT-disabled mode for subsequent running of the application based on which of the modes is more efficient during running of the software application.

5. The central processing unit of claim 1, wherein the central processing unit is operable to disable the HT-enabled mode if an application running on the computing system has code for signaling to the computer system to disable the HT-enabled mode.

6. The central processing unit of claim 1, wherein the central processing unit is operable to switch between the HT-enabled and HT-disabled modes on the basis of information stored in a library.

7. A method of using the central processing unit of claim 1, the method comprising using the central processing unit with a computing system and switching between HT-enabled and HT-disabled modes without rebooting the computer.

8. The method of claim 7, further comprising disabling the HT-enabled mode if an application running on the computing system has code signaling to the system to disable the HT-enabled mode.

9. The method of claim 7, further comprising:
launching a software application on the computing system; and then
performing performance checks in both the HT-enabled and HT-disabled modes; and then
selecting the HT-enabled mode or the HT-disabled mode for subsequent running of the application based on which of the modes is more efficient during running of the software application.

10. The method of claim 9, further comprising entering the outcome of the performance checks into a local library, the library being accessible for subsequent reference for configuration of the central processing unit regarding the HT-enabled and the HT-disabled modes.

11. The method of claim 10, further comprising cross-referencing entries of the library for multiple software applications and selecting the optimal mode based on the entries.

12. The method of claim 11, wherein a periodic spot check for performance is performed during running of the multiple software applications on the computing system.

13. The method of claim 9, further comprising manually disabling the performance checks or either of the HT-enabled and HT-disabled modes.
